(19) United States
(12) Patent Application Publication
(10) Pub. No.: US 2006/0224273 A1
(43) Pub. Date: Oct. 5, 2006

(54) Method and system for packing and delivering products

(75) Inventors: Mei-Hsiu Cheng, Taipei (TW); Mei-Chi Kuo, Taipei (TW); Wen-Yi Chang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/096,338

(22) Filed: Mar. 31, 2005

(51) Int. Cl. G06F 7/00

(52) U.S. Cl. 700/215; 700/216

(57) ABSTRACT

A method and a system for packing and delivering products are suitable for delivery of products with additional equipment. The method outputs a size serial number of a package containing a product and its additional equipment to improve the packing efficiency according to a product order. The system includes an order reading module, a serial number outputting unit, a processing unit, and a data generating module, which cooperate with the method to identify according to the product order whether additional equipment is ordered together with a product, so as to generate size serial numbers of packages for the product and its additional equipment and a size serial number of a delivery package for accommodating the packed product and additional equipment, such that the product and additional equipment can be encased into the delivery package and delivered together, thereby shortening the delivery time and reducing the risk of loss during delivery.

### FIELD OF THE INVENTION

The present invention relates to product delivery and packing management techniques, and more particularly, to a method and system for in advance identifying package sizes required for a product and its additional equipment and a size of a delivery package for accommodating the packed product and additional equipment, so as to deliver the product and its additional equipment together that are ordered by a client and shorten the overall delivery time.

### BACKGROUND OF THE INVENTION

A current Original Equipment Manufacturer (OEM) takes orders from its enterprise clients and manufactures products complying with requirements for the clients. The products are labeled with business trademarks of the enterprise clients and then sold by the clients. Thus, the OEM usually produces many similar products under different trademarks, and it is also responsible for packing the products before they can be delivered to and sold by the clients. For example, an OEM for notebook computers should encase all basic equipment such as batteries, transformers, software CDs, instruction manuals and so on into product packages during a packing process of the notebook computers before delivering the products to clients.

However, product orders from the enterprise clients may contain additional equipment such as external CD-ROM drives, external floppy disk drives, backup batteries and so on in addition to the notebook computers and basic equipment thereof. Since the current packages for notebook computers can only accommodate the notebook computers and basic equipment thereof, in such case, small additional equipment may possibly be incorporated into the packages, but large additional equipment such as external CD-ROM drives, external floppy disk drives, backup batteries and so on is not able to be packed in the same packages for the notebook computers. Conventionally, additional packages are prepared to encase the large additional equipment for delivery. This however makes the notebook computers and their additional equipment not able to be delivered together, thereby degrading the packing and delivery efficiency. Moreover, as the notebook computers and their additional equipment cannot be delivered at the same time, the risk of loss during delivery is raised. On the other hand, the clients after receiving the notebook computers have to wait for another period of time for the additional equipment to arrive before they can perform functions provided by the additional equipment. This results in inconvenience and waste of time for the clients.

Therefore, the problem to be solved here is to provide a technique for in advance identifying packages required for products and additional equipment thereof during a packing process for the products, so as to pack and deliver the products and additional equipment thereof together, and shorten the delivery time and improve the delivery efficiency.

### SUMMARY OF THE INVENTION

In light of the above drawbacks in the prior art, a primary objective of the present invention is to provide a method and system for packing and delivering products, which can in advance identify packages required for a product and its additional equipment, so as to pack and deliver the product and its additional equipment together.

Another objective of the present invention is to provide a method and system for packing and delivering products, whereby a product and its additional equipment ordered by a client can be firstly packed respectively by individual packages, and are then encased together into a delivery package, such that the prior-art problem of failure in delivering the product and its additional equipment at the same time is solved.

A further objective of the present invention is to provide a method and system for packing and delivering products, which can provide a size serial number of a delivery package for a product to a packager who is thus able to prepare the delivery package in advance, thereby improving the efficiency of a packing process for the product.

In accordance with the foregoing and other objectives, the present invention proposes a method and system for packing and delivering products.

The method for packing and delivering products in the present invention utilizes a system for packing and delivering products to arrange packages required for products and additional equipment thereof. The method comprises the steps of: (1) having the system read a product order and determine whether additional equipment is ordered together with a product in the product order, if yes, proceeding to step (3), if no, proceeding to step (2); (2) having the system generate a size serial number of a package corresponding to the product, then proceeding to step (5); (3) having the system identify whether the additional equipment can be packed with the product, if yes, returning to step (2), if no, proceeding to step (4); (4) having the system generate a size serial number of a package for each of the product and its additional equipment; and (5) having the system generate reference data for delivery and packing of the product.

The system for packing and delivering products in the present invention comprises: (1) an order reading module for collecting data including quantities and model numbers of a product and its additional equipment in a product order; (2) a serial number outputting unit for generating corresponding serial numbers of the product and its additional equipment respectively according to the collected data; (3) a processing unit for collecting and processing the serial numbers of the product and its additional equipment to generate size serial numbers of packages required for the product and its additional equipment respectively; and (4) a data generating module for generating reference data for delivery and packing of the product according to the product order and the serial numbers.

### BRIEF DESCRIPTION OF THE DRAWINGS

The present invention can be more fully understood by reading the following detailed description of the preferred embodiments, with reference made to the accompanying drawings, wherein:

FIG. 1 is a flowchart showing steps of a method for packing and delivering products according to the present invention; and

FIG. 2 is a block diagram showing architecture of a system for packing and delivering products according to the present invention.

### DETAILED DESCRIPTION OF THE PREFFERED EMBODIMENTS

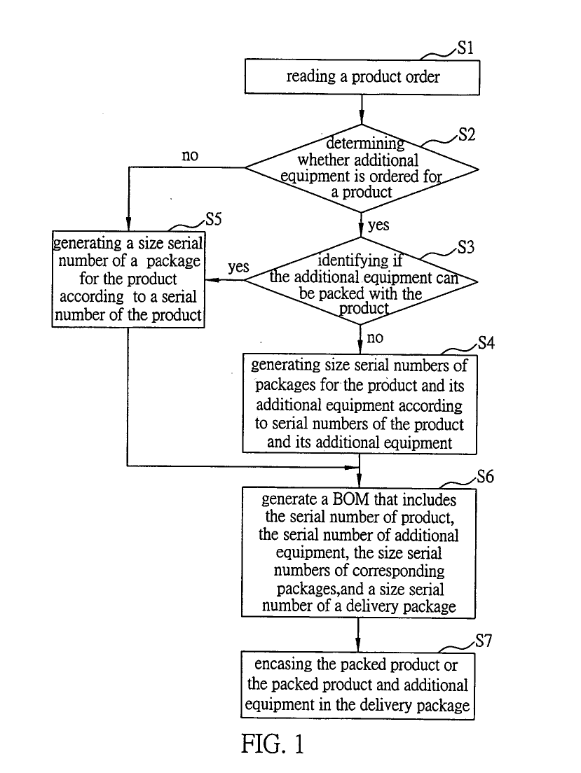

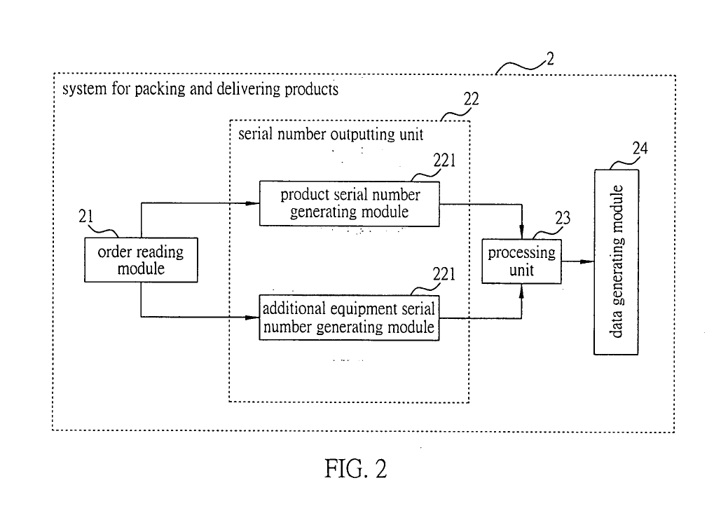

Preferred embodiments for a method and system for packing and delivering products proposed in the present invention are described below with reference to FIGS. 1 and 2, but do not set a limitation to the scope of the present invention.

FIG. 1 is a flowchart showing steps of the method for packing and delivering products according to the present invention. This method utilizes a system for packing and delivering products to perform delivery and packing processes for a product and its additional equipment. As shown in FIG. 1, firstly, in step S1, the system reads an electronic product order to compute and identify a name, model number and quantity of a product ordered by a client. Then, the method proceeds to step S2.

In step S2, the system determines according to the product order whether the client orders additional equipment for the product, so as to decide if the product (such as a notebook computer) and its additional equipment (such as a battery, external CD-ROM drive, external floppy disk drive, and so on) are to be delivered together. If it is determined that the additional equipment is ordered for the product, the method proceeds to step S3; otherwise, the method proceeds to step S5.

In step S3, the system determines whether the additional equipment ordered by the client can be packed with the product according to the specification of the additional equipment so as to save usage of packages. If the product and its additional equipment can be packed together, the method proceeds to step S5; otherwise, the method proceeds to step S4.

In step S4, the system processes and generates package data such as size serial numbers of packages for the product and its additional equipment respectively according to serial numbers of the product and its additional equipment. Then, the method proceeds to step S6.

In step S5, the system processes and generates a size serial number of a package for the product according to a serial number of the product. Then, the method proceeds to step S6.

In step S6, according to the product order and the serials numbers obtained in the foregoing steps, the system processes and generates reference data (i.e. a BOM, Bill of Material) that contain the serial number of product, the serial number of additional equipment, the size serial number of product package, the size serial number of additional equipment package, and a size serial number of a delivery package for accommodating the packed product or the packed product and additional equipment. This allows a packager to in advance prepare required packages so as to improve the efficiency of the packing process. Then, the method proceeds to step S7.

In step S7, the packager encases the packed product or the packed product and additional equipment into the delivery package that is then delivered to the client.

FIG. 2 is a block diagram showing architecture of the system for packing and delivering products according to the present invention. As shown in FIG. 2, the system for packing and delivering products 2 in the present invention comprises an order reading module 21, a serial number outputting unit 22, a processing unit 23, and a data generating module 24. The serial number outputting unit 22 comprises a product serial number generating module 221, and an additional equipment serial number generating module 222.

The order reading module 21 is used to collect data including quantities, names and model numbers of a product and its additional equipment in a product order. The collected data serve as reference for subsequent processes performed by the system for packing and delivering products 2.

The serial number outputting unit 22 is used to process the collected data from the order reading module 21 and identify whether additional equipment is ordered together with the product ordered by a client. If yes, the product serial number generating module 221 generates a serial number corresponding to the product, and the additional equipment serial number generating module 222 generates a serial number corresponding to the additional equipment.

The processing unit 23 is used to collect and process the serial numbers generated from the serial number outputting unit 22. According to the serial numbers, the processing unit 23 retrieves a size serial number of a package for the product and a size serial number of a package for the additional equipment. Moreover, the processing unit 23 generates a size serial number of a delivery package required for the packed product or for the packed product and additional equipment.

The data generating module 24 is used to process and generate reference data (i.e. a BOM, Bill of Material) that contain the serial number of product, the serial number of additional equipment, the size serial number of product package, the size serial number of additional equipment package, and the size serial number of delivery package for accommodating the packed product or the packed product and additional equipment. This allows a packager to in advance prepare required packages so as to improve the efficiency of a packing process.

The invention has been described using exemplary preferred embodiments. However, it is to be understood that the scope of the invention is not limited to the disclosed embodiments. On the contrary, it is intended to cover various modifications and similar arrangement. The scope of the claims therefore should be accorded the broadest interpretation so as to encompass all such modifications and similar arrangements.

What is claimed is:

1. A method for packing and delivering products, which is suitable for delivery of products with additional equipment and utilizes a system for packing and delivering products to arrange packages required for the products and the additional equipment thereof, the method comprising the steps of:
(1) having the system read a product order and determine whether additional equipment is ordered together with a product in the product order, if yes, proceeding to step (3), if no, proceeding to step (2);
(2) having the system generate data of a package corresponding to the product, then proceeding to step (4);
(3) having the system generate data of packages corresponding to the product and its additional equipment respectively; and
(4) having the system generate reference data for delivery and packing of the product.

2. The method of claim 1, further comprising in step (1) before proceeding to step (3), having the system identify whether the additional equipment is able to be packed with the product, if yes, proceeding to step (2), if no, proceeding to step (3).

3. The method of claim 1, further comprising after step (4), encasing the packed product or the packed product and additional equipment into a delivery package according to the reference data comprising a bill of material (BOM).

4. The method of claim 1, wherein the reference data for delivery and packing of the product include a serial number of the product, a serial number of the additional equipment, and size serial numbers of the packages corresponding to the product and the additional equipment.

5. The method of claim 1, wherein the reference data for delivery and packing of the product include a size serial number of a delivery package.

6. The method of claim 1, wherein the product and its additional equipment have different serial numbers from each other.

7. A system for packing and delivering products, which is suitable for delivery of products with additional equipment, the system comprising:
an order reading module for collecting data including quantities and model numbers of a product and its additional equipment in a product order;
a serial number outputting unit for generating serial numbers of the product and its additional equipment respectively according to the collected data;
a processing unit for collecting and processing the serial numbers of the product and its additional equipment to generate size serial numbers of corresponding packages; and
a data generating module for generating reference data for delivery and packing of the product according to the serial numbers and the product order.

8. The system of claim 7, wherein the serial number outputting unit includes a product serial number generating module and an additional equipment serial number generating module.

9. The system of claim 7, wherein the reference data comprise a BOM (Bill of Material).

10. The system of claim 7, wherein the reference data for delivery and packing of the product include the serial number of the product, the serial number of the additional equipment, and the size serial numbers of the packages corresponding to the product and the additional equipment.
